(19) United States
(12) Patent Application Publication
(10) Pub. No.: US 2026/0204067 A1
(43) Pub. Date: Jul. 16, 2026

(54) GENERATING A USER GUIDE FROM VIDEO

(71) Applicant: International Business Machines Corporation, Armonk, NY (US)

(72) Inventors: Kun Yan Yin, NINGBO (CN); Wen Wang, Beijing (CN); Yi Chen Zhong, Shanghai (CN); Chao Dong, Ningbo (CN)

(21) Appl. No.: 19/017,380

(22) Filed: Jan. 10, 2025

(51) Int. Cl. G06V 20/40; G06F 40/166; G06V 10/70; G06V 40/20; G10L 15/16

(52) U.S. Cl. CPC G06V 20/47; G06F 40/166; G06V 10/70; G06V 20/41; G06V 40/20; G10L 15/16

(57) ABSTRACT

An example operation includes one or more of receiving video content of an operation being performed, generating, via a first machine learning (ML) model and based on the video content, a description of at least one action being performed that is part of the operation, extracting, via a second ML model, spoken utterances from the video content, generating a digital document that includes a textual description of steps that are performed to perform the operation and image placeholders, based on execution of a third ML model on the description of the at least one action and the spoken utterances that are extracted, wherein the digital document is an output of the third ML model, and adding digital images to the digital document based on the image placeholders.

### BACKGROUND

In a factory or other setting where users perform operations on objects such as machines, tools, equipment, and the like, user guides or manuals are helpful. For example, a user guide may provide a combination of textual descriptions and images that show and describe how to perform a particular task.

### SUMMARY

One example embodiment provides a method that may include one or more of receiving video content of an operation being performed, generating, via a first machine learning (ML) model and based on the video content, a description of at least one action being performed that is part of the operation, extracting, via a second ML model, spoken utterances from the video content, generating a digital document that includes a textual description of steps that are performed to perform the operation and image placeholders, based on execution of a third ML model on the description of the at least one action and the spoken utterances that are extracted, wherein the digital document is an output of the third ML model, and adding digital images to the digital document based on the image placeholders.

Another example embodiment provides a computer system that may include a processor set, one or more computer-readable storage media, and program instructions stored on the one or more computer-readable storage media to cause the processor set to perform operations comprising: receiving video content of an operation being performed, generating, via a first machine learning (ML) model and based on the video content, a description of at least one action being performed that is part of the operation, extracting, via a second ML model, spoken utterances from the video content, generating a digital document comprising a textual description of steps that are performed to perform the operation and image placeholders, based on execution of a third ML model on the description of the at least one action and the spoken utterances that are extracted, wherein the digital document is an output of the third ML model, and adding digital images to the digital document based on the image placeholders.

A further example embodiment provides a computer program product that may include one or more computer-readable storage media, and program instructions stored on the one or more computer-readable storage media to perform operations comprising: receiving video content of an operation being performed, generating, via a first machine learning (ML) model and based on the video content, a description of at least one action being performed that is part of the operation, extracting, via a second ML model, spoken utterances from the video content, generating a digital document comprising a textual description of steps that are performed to perform the operation and image placeholders, based on execution of a third ML model on the description of the at least one action and the spoken utterances that are extracted, wherein the digital document is an output of the third ML model, and adding digital images to the digital document based on the image placeholders.

### BRIEF DESCRIPTION OF THE DRAWINGS

FIG. 1 is a diagram illustrating a computing environment according to an embodiment of the instant solution.

FIG. 2 is a diagram illustrating a system for generating a user guide document from video according to examples and features of the instant solution.

FIG. 3A is a diagram illustrating a process of identifying an action being performed in a video according to examples and features of the instant solution.

FIG. 3B is a diagram illustrating a process of extracting audio from the video according to examples and features of the instant solution.

FIG. 3C is a diagram illustrating a process of generating a descriptive summary of the video according to examples and features of the instant solution.

FIG. 3D is a diagram illustrating a process of generating a user guide document from a prompt according to the examples and features of the instant solution.

FIG. 3E is a diagram illustrating a process of filling in the user guide document with image content according to the examples and features of the instant solution.

FIG. 4A is a flow diagram illustrating a method according to examples and features of the instant solution.

FIG. 4B is a flow diagram illustrating a method according to additional examples and features of the instant solution.

FIG. 5A is a system diagram illustrating integration of an AI model into any decision point according to the examples and features of the instant solution.

FIG. 5B is a diagram illustrating a process for developing an AI model that supports AI-assisted computer decision points according to the examples and features of the instant solution.

FIG. 5C is a diagram illustrating a process for utilizing an AI model that supports AI-assisted computer decision points according to examples and features of the instant solution.

FIG. 6 is a diagram illustrating a view of a prompt that can be input to an ML model according to examples and features of the instant solution.

FIG. 7 is a diagram illustrating a view of a list of steps that can be input to a multi-modal ML model according to examples and features of the instant solution.

FIG. 8 is a diagram illustrating a view of a user guide document that is generated according to examples and features of the instant solution.

### DETAILED DESCRIPTION

It is to be understood that although this disclosure includes a detailed description of cloud computing, implementation of the teachings recited herein is not limited to a cloud computing environment. Rather, embodiments of the instant solution are capable of being implemented in conjunction with any other type of computing environment now known or later developed.

User guides are critical for workers and employees who are performing tasks at a factory, warehouse, maintenance location, and the like. In many cases, user guides include images which quickly help users see the instructions rather than solely relying on written descriptions, because written descriptions without any complementary visual aids may not achieve precise instructional outcomes. When writing a user guide or manual, management personnel must rely on on-site operational experience or videos to compose the manuals. This reliance typically requires a person to watch the video, comprehend the steps being performed, and manually write the user guide and select images for inclusion in the user guide.

Over time, the steps that are performed for a particular task may be modified by the organization, for example, for purposes of safety, new parts, better methods, and the like. In instances where operational procedures are frequently updated, synchronizing instructional videos and user manuals becomes challenging. Such delays can result in a lack of timely dissemination of standard specifications. Furthermore, when changing operational steps, existing user manuals and videos become obsolete, requiring a time-consuming re-recording process.

The example embodiments are directed to a system which can use machine learning to automatically generate a user guide from video content of an operation being performed. The system may analyze video content and detect objects and postures of a person or persons within the video with respect to the objects to determine detailed behaviors and steps that are performed. The system can also extract audio and language subtitle information from the video. The system can also generate a summary of the video (e.g., a summary of the operation being performed). The system may generate a prompt which includes the behaviors and steps performed, the audio, and/or the video summary, and input the prompt into a machine learning model. In response, the ML model may generate a digital document (e.g., JavaScript Object Notation (JSON), PDF, and/or the like) with a description and images of the steps being performed.

In video tutorials, explanations can sometimes be rudimentary. To address this, the system can execute action recognition models on frames of a video to automatically identify user actions. Th user action(s) that are identified serve as supplementary content for a deeper understanding of the video content and introduce additional local features. Furthermore, audio of the video may contain information that is not shown in the video. By extracting the audio and using a combination of the description of steps performed in the video and the spoken words or utterances contained in the audio, the system can ensure a comprehensive user guide is generated.

For example, a perfect video of an operation being performed by a person may include a video that shows the user performing each of the steps and audio which describes in detail each of the steps being performed. However, in most cases, such a perfect video does not exist. For example, the users/operators in the video may not provide verbal explanations for each operation. The example embodiments overcome this problem by relying on a combination of the video content and the audio content from the video to generate the user guide, resulting in comprehensive operation guidance. Furthermore, the system can reduce the inconsistency between the user guides and the video demos in almost real-time by updating a user guide for a particular operation using the system described herein when the video demo of the particular operation is modified.

The instant features, structures, or characteristics as described throughout this specification may be combined or removed in any suitable manner in one or more embodiments. For example, the usage of the phrases “example embodiments,” “some embodiments,” or other similar language, throughout this specification refers to the fact that a particular feature, structure, or characteristic described in connection with the embodiment may be included in at least one embodiment. Thus, appearances of the phrases “example embodiments,” “in some embodiments,” “in other embodiments,” or other similar language, throughout this specification do not necessarily all refer to the same group of embodiments, and the described features, structures, or characteristics may be combined or removed in any suitable manner in one or more embodiments. Further, in the diagrams, any connection between elements can permit one-way and/or two-way communication even if the depicted connection is a one-way or two-way arrow. Also, any device depicted in the drawings can be a different device. For example, if a mobile device is shown sending information, a wired device could also be used to send the information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner that is at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

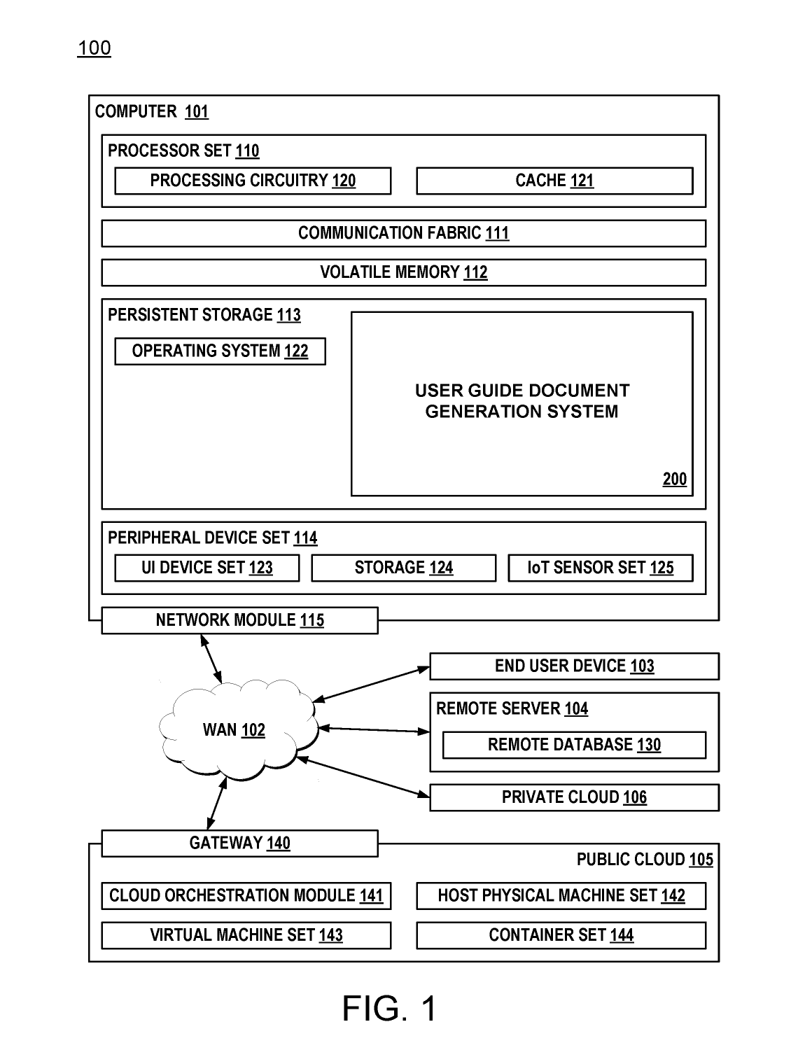

Referring to FIG. 1, computing environment 100 contains an example of an environment for the execution of at least some of the computer code involved in performing the inventive methods, such as user guide document generation system (block 200). In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read-only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

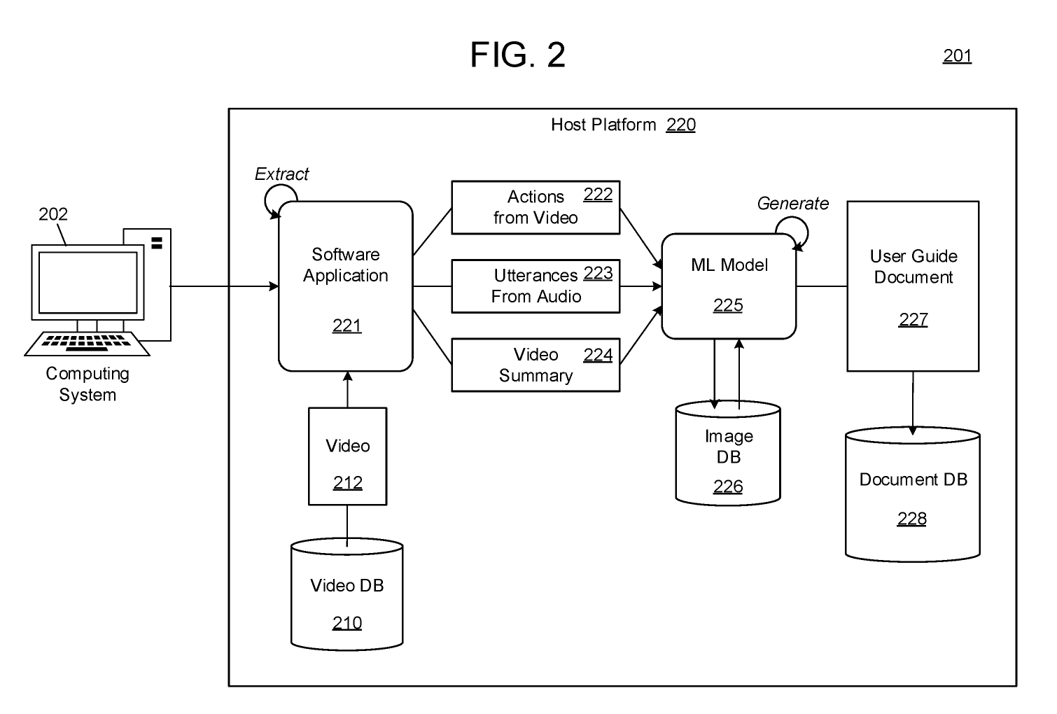

FIG. 2 illustrates a system 201 for generating a user guide document from video according to examples and features of the instant solution. Referring to FIG. 2, a host platform 220 may host a software application 221 which is capable of generating a user guide from video content. The host platform 220 may be a cloud platform, a web server, a database, a distributed network of systems, an on-premises server, and the like. The software application 221 may be a web application that is accessible from a browser (e.g., web browser, mobile browser, etc.). For example, a computing system 202 such as a desktop computer, a mobile device, or the like, may connect to the host platform 220 over a network such as the Internet, a private network, and the like, and access the software application 221 over the network. To do this, a user may input a web address (e.g., IP address, etc.) of the software application 221 into a browser installed on the computing system 202.

After accessing the software application 221, the user may instruct the software application 221 to generate a user guide for an operation performed by a person. Here, the user may enter a command into a graphical user interface (GUI) of the software application 221 which requests that the user guide be generated based on a video 212 (video content) of the operation. The video 212 may be retrieved from a video database 210 which may be local on the host platform 220 or an external system such as a website, an external database, or the like.

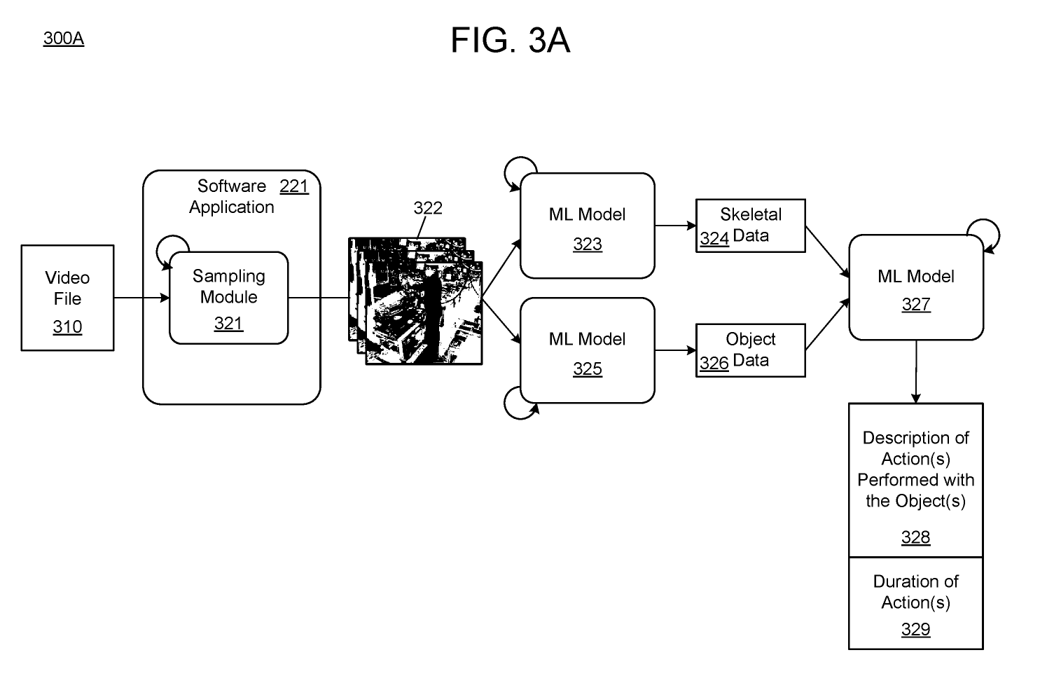

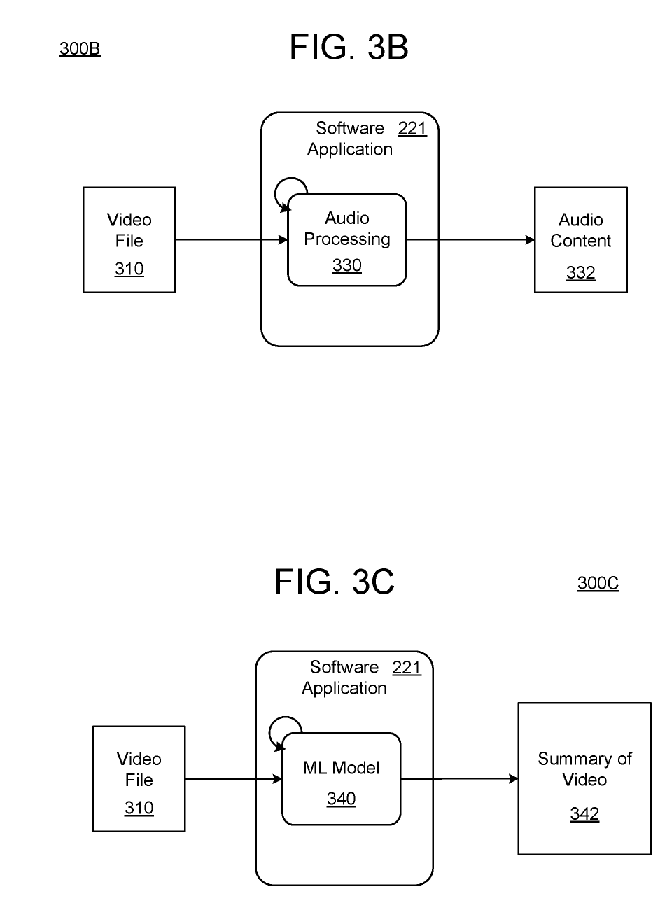

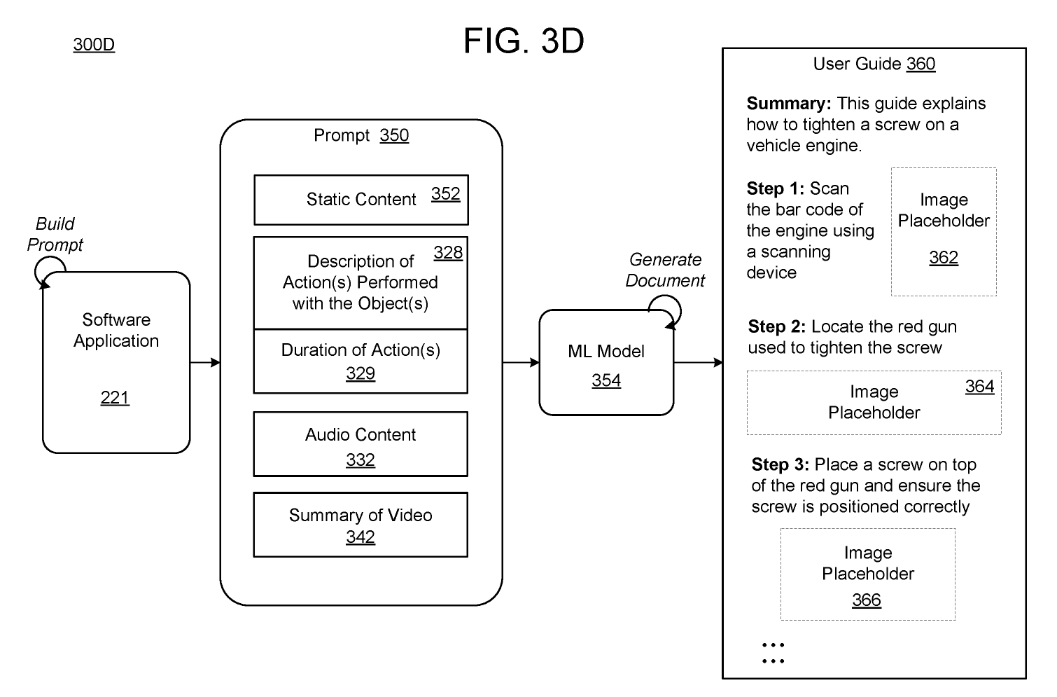

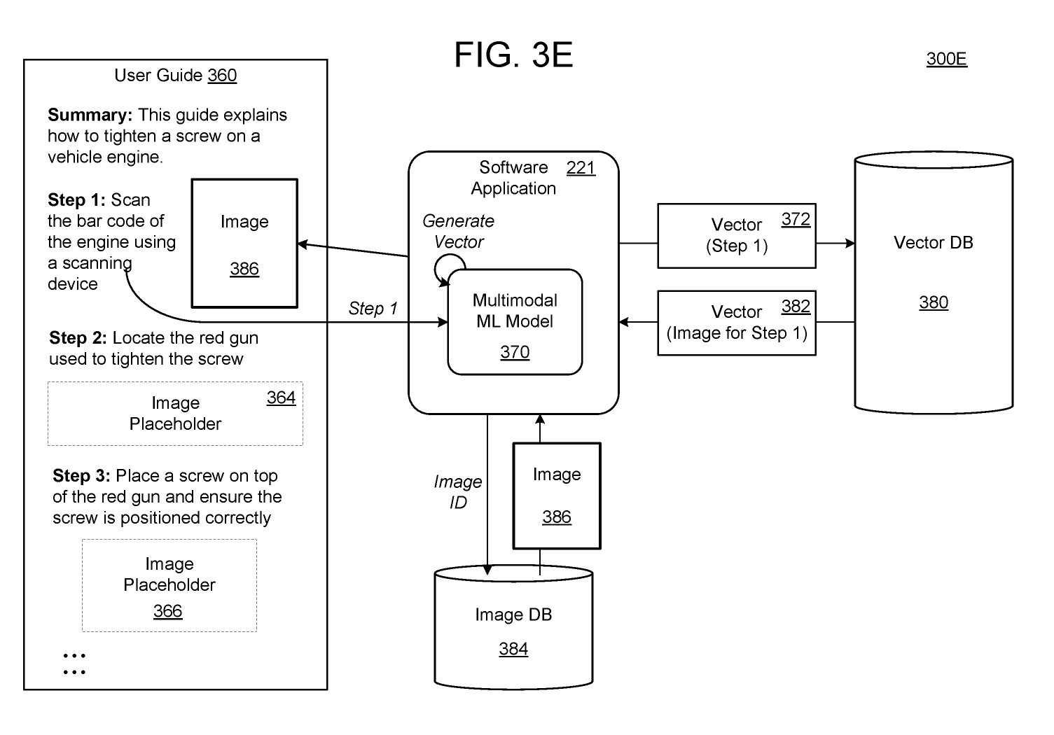

The software application 221 may retrieve the video 212 and analyze the video to extract multiple types of content/data from the video 212. For example, the software application 221 may extract a description of at least one action 222 performed by a person within the video 212, utterances within the audio 223 (e.g., speech, dialog, etc.) that are spoken/uttered by the person during the video 212, a summary description 224 of the video 212, and/or the like. Examples of generating the description of the at least one action 222 are described with respect to FIG. 3A, examples of extracting the utterances within the audio 223 are described with respect to FIG. 3B, and examples of generating the video summary from the video 212 are described with respect to FIG. 3C.

Referring again to FIG. 2, the software application 221 may input the description of the at least one action 222 performed by the person within the video 212, the utterances within the audio 223 that are spoken/uttered by the person during the video 212, and the summary description 224 derived from the video 212 into an ML model 225 with generative capabilities that can generate a user guide document 227 (e.g., JSON, XML, PDF, etc.). The user guide document 227 may include a description of steps that are to be performed by a person when performing the operation.

The user guide document 227 may also include images pulled from the video 212 (and stored in an image database 226). The images may be added to the user guide document 227 at relevant locations with respect to the steps in the document. Furthermore, the user guide document 227 may be stored within a document database 228 along with an identifier of the operation that is guided by the user guide document 227. Examples of operations include, but are not limited to, maintenance operations, installation instructions, manufacturing operations, factory operations, and the like.

FIG. 3A illustrates a process 300A of identifying an action being performed in a video according to examples and features of the instant solution. Referring to FIG. 3A, the software application 221 may determine actions performed by a user with respect to an object from video content using machine learning. As an example, the actions may refer to manufacturing operations performed by a worker who is part of the manufacturing process (e.g., using tools and equipment to build an item, using tools and equipment to perform maintenance on an item, using their hands (with or without a tool), etc. to perform some action on an item, etc.) The video may be composed of operation actions performed by a person and audio (user utterances/speech) that is captured. In some instances, the video already includes textual captions that match the user speech from the video, so the textual captions are available to be extracted or retrieved from the video data without needing to do speech-to-text transcription. What the person does in the video and what they say in the video may not be perfectly aligned. By using a combination of both video content (images) and verbal/spoken content (utterances), the system can generate a more comprehensive user guide compared to using just video.

According to various embodiments, the software application 221 may sample a plurality of video frames from video content (e.g., a video file 310) that includes a video of an operation being performed by a person. The software application 221 may include a sampling module 321 that can sample frames 322 at a predefined frequency (e.g., 1 frame per second, 3 frames per second, 5 frames per second, etc.) The frames 322 may include still images extracted from the video, for example, a sequence of still images that make up the video file 310, etc.

The software application 221 may execute a first ML model 323 on the frames 322 to identify skeletal data 324 of the person within the frames 322. For example, the first ML model 323 may be trained to identify the shape of a skeletal frame (e.g., bones, etc.) of the person from the image content, the position of the skeleton, etc. The software application 221 may also execute a second ML model 325 on the frames 322 to identify object data 326 within the video. The object data 326 may include identifications of objects such as tools, equipment, items, vehicles, systems, and the like that are also shown in the video file 310 and frames 322. The second ML model 325 implements an object detection algorithm such as YOLO (You Only Look Once) in order to perform the object detection and generate the object data 326.

In some embodiments, the agent recorded in the video performing the one or more actions is a robot so the skeletal frame refers to physical structure of the robot and not to an actual human skeleton. References herein to a human may also encompass performance by a robot. References to “agent” encompass both a human and a robot which may perform actions in a video. The ML model that performs the skeletal frame identification is in various embodiments trained in advance using supervised learning with samples of a relevant class of agents, such as humans. If a robot of a particular structural style is intended to be identified, the ML model is trained in advance using samples of other robots with that particular structural style. The training can help the ML model perform posture detection of the agent (human or robot) who is performing an action in a video.

The software application 221 may execute a third ML model 327 on the skeletal data 324 and the object data 326 to generate a description of at least one action 328 being performed by the person/agent with respect to the object or objects in the video. As an example, the third ML model 327 may determine that the person is performing a particular type of action (e.g., holding, turning, moving, stopping, activating, driving, etc.) with respect to an object (e.g., a tool, a piece of equipment, a vehicle, etc.) The third ML model 327 may also determine a duration of each action 329 using timestamps from the video frames. The duration of each action 329 may include an identifier of the action, a start time, an end time, and the like.

FIG. 3B illustrates a process 300B of extracting audio from the video according to examples and features of the instant solution. FIG. 3C illustrates a process 300C of generating a descriptive summary of the video according to examples and features of the instant solution. Referring to FIG. 3B, the software application 221 may include an audio processing module 330 that is capable of extracting audio content 332 (e.g., an audio file, spoken utterances, noises, etc.) from the video file 310. The audio content 332 may be stored within a computer file, a media file, and the like. The audio processing module 330 may also include a speech-to-text module (not shown) which can convert the audio content 332 into text and store the text within the audio content 332. In some embodiments, the audio content 332 may contain the text without the actual audio file. However, the audio content 332 may include both the text and the audio or just the audio.

Referring now to FIG. 3C, the software application 221 may generate a summary of the video 342. For example, the software application 221 may include a ML model 340 that can generate a description/summary of the content within the video file 310. The summary of the video 342 may include a description of what is being performed by the person in the video. For example, the summary of the video 342 may recite “A user is attaching an updated module to a boiler system in this video.” The summary of the video 342 may be stored within an electronic document, or the like. In some embodiments, the ML model 340 that generates the summary is a Video-LLaMa that includes a combination of BLIP-2 and MiniGPT-4 to process and comprehend videos. BLIP-2 includes a frozen image encoder, a frozen Large Language Model (LLM), and a Querying Transformer. MiniGPT-4 is a multi-modal LLM that can accept text, image, video, and/or audio data as inputs and generate these similar things as outputs. In some embodiments, the summary 342 is generated by submitting the video file 310 as well as a textual prompt both into the ML model 340, with the textual prompt providing instructions to generate the summary for the video file 310. For example, in one embodiment the prompt says, “Summarize this video in one sentence.”

FIG. 3D illustrates a process 300D of generating a user guide document 360 from a prompt according to the examples and features of the instant solution. Referring to FIG. 3D, the software application 221 may construct a prompt 350 based on a prompt template that includes static content 352. In addition, the prompt 350 may include dynamic content, for example, at least one of the description of the at least one action 328, the duration of the at least one action 329, the audio content 332, and the summary of the video 342. The software application 221 may input the prompt 350 to a ML model 354, such as a foundation model, e.g., a generative ML model (e.g., LLM, etc.) In response, the ML model 354 may generate a user guide document 360.

For example, the user guide document 360 may include a description of steps performed by the person in the video including a sequence of the steps, and actions and objects associated with each step. The user guide document 360 may also include a descriptive summary which provides an overview of the operation being performed. The ML model 354 may generate the sequence of steps based on instructions that are included in the static content 352 in the prompt 350. For example, the instructions may describe what text and images should be included in the user guide document 360. The prompt 350 may indicate a format of the desired user guide document 360, such as the format type of the digital document, color and selection of one or more fonts to be used, quality of images to be included, etc. The prompt 350 may include examples of other digital documents which should be examples or a basis for the intended digital document to be created.

Based on the prompt 350, the ML model 354 may generate image placeholders for at least one of the steps. In the example of FIG. 3D, the ML model 354 may generate an image placeholder 362 corresponding to a first step, an image placeholder 364 corresponding to a second step, and an image placeholder 366 corresponding to a third step, etc. The image placeholders 362, 364, and 366 may include metadata such as pixel coordinates of where the image is to be placed within the document, a description of the corresponding step associated with the image placeholder, and the like. The description may be used by the software application 221 to identify and retrieve images that are then added to the user guide document 360.

FIG. 6 illustrates a view 600 of a prompt 610 that can be input to the ML model 354 to generate the user guide document. In this example, the prompt 610 includes a list of actions 611 that should be included in the user guide document, a list of captions 612 that should be recited in the user guide document, a summary 613 of the video, a task 614 to be performed by the ML model 354, an output format 615 of the output of the ML model 354, and an example format 616 of the output of the ML model 354. The ML model 354 may use the prompt 610 to build the user guide document.

FIG. 3E illustrates a process 300E of filling in the user guide document with image content according to the examples and features of the instant solution. Referring to FIG. 3E, the software application 221 may include a multi-modal ML model 370 that can be used to convert text and image data into vectors. The software application 221 may generate a function that calls for images as described herein. Here, the multi-modal ML model 370 may be trained to understand correlations between text and images that correspond to the text. For example, the multi-modal ML model 370 may receive metadata from an image placeholder and/or content from the user guide document 360 and convert it into a vector. For example, the multi-modal ML model 370 may receive a description of the first step from the user guide document 360 and convert it into a vector 372.

The software application 221 may also retrieve related image vectors from a vector database 380. For example, the images from the video may be stored within an image database 384, and corresponding vectors may be generated and stored within the vector database 380. According to various embodiments, the software application 221 may perform a vector space comparison of the vector 372 to vectors of images stored in the vector database 380 to identify an image vector 382 corresponding to the vector 372. The image vector 382 may include an identifier of a corresponding image which the image vector 382 represents. The software application 221 may query the image database 384 with the identifier of the corresponding image and receive an image 386 from the image database 384. The software application 221 may add the image 386 to the image placeholder 362 of the corresponding step within the user guide document 360, e.g., within the designated portion/area of the electronic document (the user guide document 360). The same process may be performed for each of the image placeholders in the user guide document 360 to fill in the user guide document 360 with images corresponding to the description of steps within the user guide document 360.

Images are relevant frames from the source video. The images from the video may be extracted and stored within an image pool in the image database 384. Furthermore, vectors may be generated from the images in the image pool using the multi-modal ML model 370. The vectors (image vectors) may be stored within the vector database 380. The software application 221 may query the vector database 380 with a ‘text description’ of each step to search for a matching image vector, and then convert the image vector into an image (or retrieve an image from the image DB 384 that corresponds to a matching vector from the vector DB 380) which is then added to the document.

For example, FIG. 7 illustrates a view 700 of a plurality of steps 710 (textual descriptions) that are used to find images corresponding to the plurality of steps 710. Each of the textual descriptions may be converted into vectors and may be used to find a plurality of images corresponding to the plurality of steps, respectively. For example, the plurality of steps 710 include a first step 711, a second step 712, a third step 713, and a fourth step 714. Each of the steps may include a timestamp 715 indicating a portion of the video during which the step is shown and described. Each description of a step can be used to find a different image in a vector database using the multi-modal ML model 370 according to example embodiments. The images that are found may then be added to the user guide document that is generated.

As another example, the software application 221 may use the duration data 329 of the steps within the video content to identify corresponding images. Here, the software application 221 may add the duration data to the image placeholders (metadata) during the user guide document generation process, and then use software to retrieve the images from the image database 384 based on the timing data. Other image adding procedures are also possible.

FIG. 8 illustrates a view 800 of a user guide document 810 generated by the ML model 354 with image placeholders 811, 812, 813, and 814 shown in the user guide document 810. Here, the system may use the image placeholders 811 to replace the text content with an image of the corresponding step which is identified from a vector database.

In various embodiments, the various ML models used to perform the steps described herein are performed by a single multi-modal ML model or using a single ML model for multiple steps of all of the steps described herein.

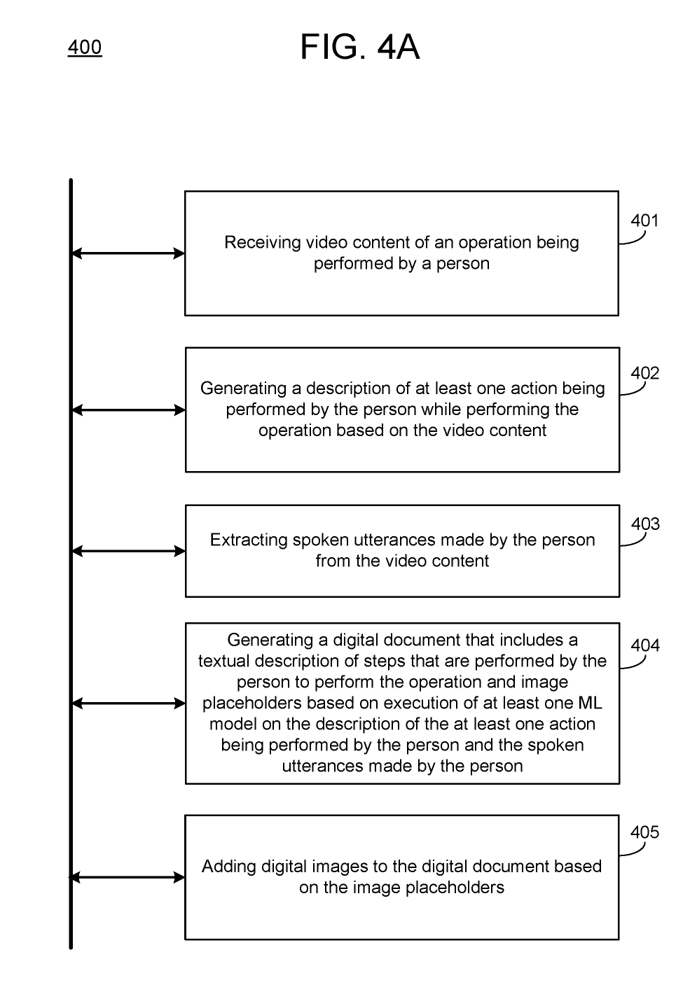

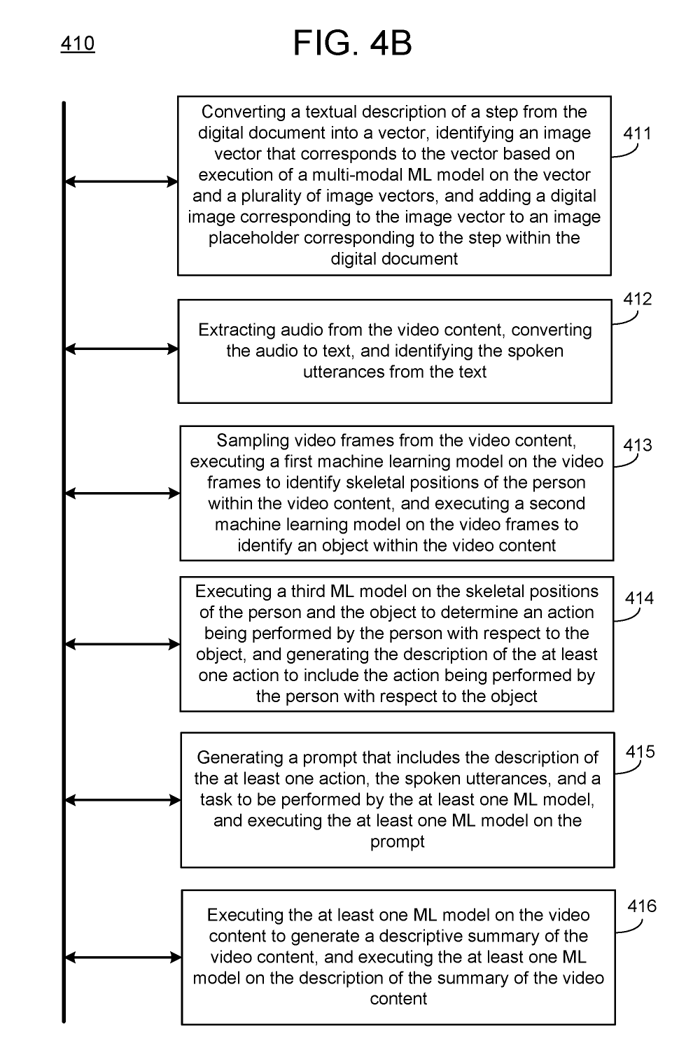

FIG. 4A illustrates a flow diagram of a method 400, according to example embodiments. Referring to FIG. 4A, in 401, the method may include receiving video content of an operation being performed. In 402, the method may include generating, via a first machine learning (ML) model and based on the video content, a description of at least one action being performed that is part of the operation. In 403, the method may include extracting, via a second ML model, spoken utterances from the video content. In 404, the method may include generating a digital document that includes a textual description of steps that are performed to perform the operation and image placeholders, based on execution of a third ML model on the description of the at least one action and the spoken utterances that are extracted, wherein the digital document is an output of the third ML model. In 405, the method may include adding digital images to the digital document based on the image placeholders.

FIG. 4B illustrates a flow diagram of a method 410, according to example embodiments. Referring to FIG. 4B, in 411, the method may include converting a textual description of a step from the digital document into a vector, identifying an image vector that corresponds to the vector based on execution of a multi-modal ML model on the vector and multiple image vectors, and adding a digital image corresponding to the identified image vector to an image placeholder corresponding to the step within the digital document. In 412, the method may include extracting audio from the video content, converting the audio to text, and identifying the spoken utterances from the text.

In 413, the method may include sampling video frames from the video content, executing the first machine learning model on the video frames to identify skeletal positions of an agent within the video content, and executing the first machine learning model or another machine learning model on the video frames to identify an object within the video content, and wherein the description of the at least one action is based on the identified skeletal positions and on the identified object. In 414, the method may include executing the first ML model, the other ML model, or an additional ML model on the identified skeletal positions and the identified object to determine the action being performed by the agent with respect to the object, wherein the description of the at least one action includes the action being performed by the agent with respect to the object.

In 415, the method may include generating a prompt that includes the description of the at least one action, the extracted spoken utterances, and a task to be performed by the third ML model, wherein the generating the digital document includes executing the third ML model on the prompt. In 416, the method may include executing the third ML model on the video content to generate a descriptive summary of the video content, wherein the generating the digital document further comprises executing the third ML model on the generated descriptive summary of the video content. In 417, the first, second, and third machine learning models are the same machine learning model.

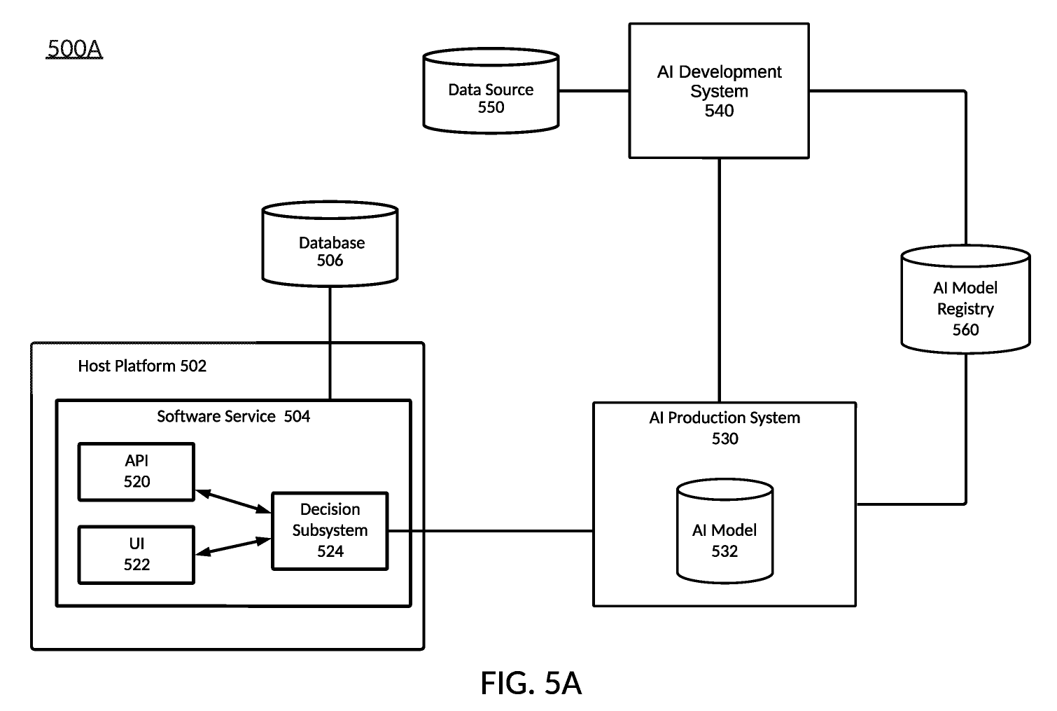

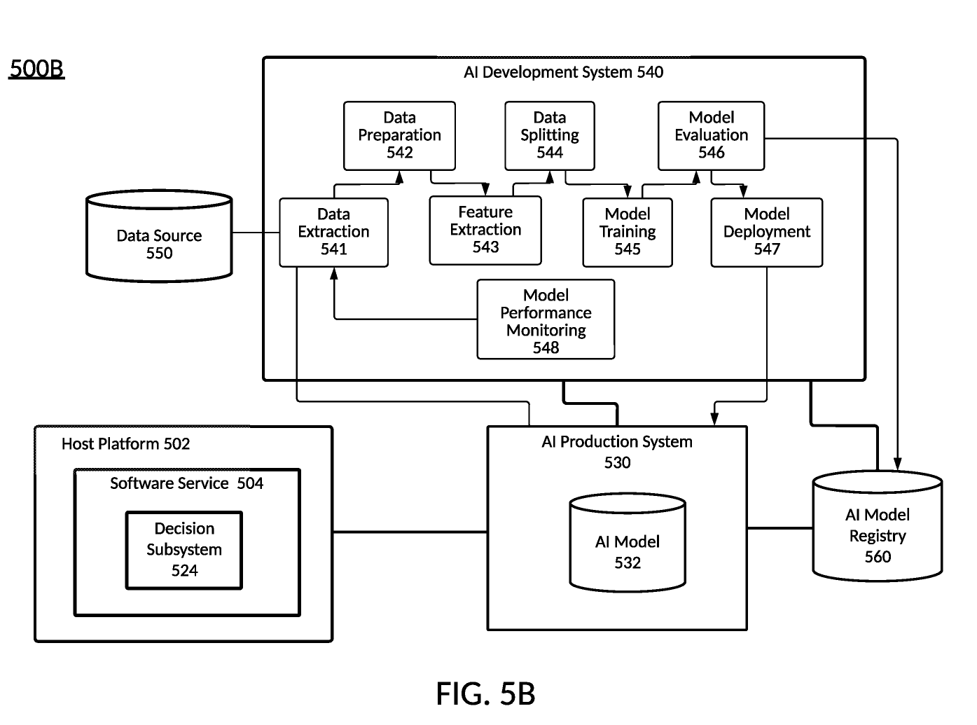

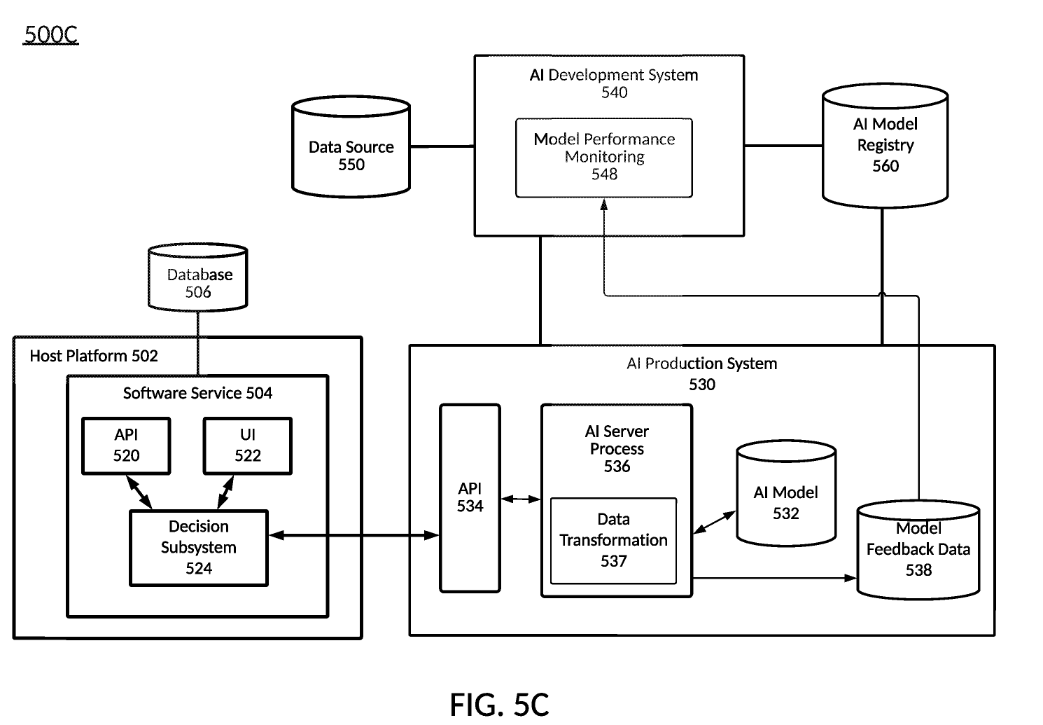

Detailed descriptions of training a machine learning model and executing a machine learning model are further described and depicted herein. The training and execution of the machine learning model described in the examples of FIGS. 5A-5C may be performed inside a confidential machine learning computing environment as described in the examples herein.

FIG. 5A illustrates an artificial intelligence (AI) network diagram 500A that supports AI-assisted decision points in a software service executing on a computer. As one example, the AI model being trained in the examples herein may refer to an AI model for any of the tasks performed herein including a machine learning model, a neural network, a large language model (LLM), and the like. While the example instant solution shown utilizes a neural network, which is a type of machine learning (ML) model, other branches of AI, such as, but not limited to, computer vision, fuzzy logic, expert systems, deep learning, generative AI, and natural language processing, may be employed in developing the AI model in this instant solution. Further, the AI model included in these examples and features of the instant solution is not limited to particular AI algorithms. Any algorithm or combination of algorithms related to supervised, unsupervised, and reinforcement learning may be employed.

The AI models, ML models, neural networks, and other branches of AI, described and/or depicted herein, build upon the fundamentals of predecessor technologies and form the foundation for all future technological advancements in artificial intelligence. An AI classification system describes the stages of AI progression and advancement. The first classification is known as "reactive machines," followed by present-day AI classification "limited memory machines" (also known as "artificial narrow intelligence"), then progressing to "theory of mind" (also known as "artificial general intelligence") and reaching the AI classification "self-aware" (also known as "artificial superintelligence"). Present-day limited memory machines are a growing group of AI models built upon the foundation of their predecessors, reactive machines. Reactive machines emulate human responses to stimuli; however, they are limited in their capabilities as they cannot typically learn from prior experience. Once the AI model's learning abilities emerged, its classification was promoted to limited memory machines. In this present-day classification, AI models learn from large volumes of data, detect patterns, solve problems, generate, and predict data, and the like, while inheriting all the capabilities of reactive machines.

Examples of AI models classified as limited memory machines include, but are not limited to, chatbots, virtual assistants, machine learning, neural networks, deep learning, natural language processing, generative AI models, and any future AI models that are yet to be developed possessing characteristics of limited memory machines.

For example, a neural network is a type of machine learning model that relies on training data to learn associations and connections, improving its accuracy for performing high speed data classifications, clustering, and other analyses of data. Such neural network capabilities are the foundation of deep learning models today as well as becoming the foundational blocks of those yet to be developed.

For example, generative AI models combine limited memory machine technologies, incorporating machine learning and deep learning, forming the foundational building blocks of future AI models. For example, theory of mind is the next progression of AI that may be able to perceive, connect, and react by generating appropriate reactions in response to an entity with which the AI model is interacting; all these theory of mind capabilities rely on the fundamentals of generative AI. Furthermore, in an evolution into the self-aware classification, AI models will be able to understand and evoke emotions in the entities they interact with, as well as possessing their own emotions, beliefs, and needs, all of which rely on generative AI fundamentals of learning from experiences to generate and draw conclusions about itself and its surroundings.

AI models may include, but are not limited to, at least one machine learning model, neural network model, deep learning model, generative AI model, or any combination of models from the branches of AI. AI models are integral and core to future artificial intelligence models. As described herein, AI model refers to present-day AI models and future AI models.

Artificial intelligence systems have been built and trained to perform various tasks in an automated manner. For example, artificial intelligence systems receive and understand verbal and/or written dialogue and function as digital assistants, speech-to-text programs, etc. Other artificial intelligence systems are trained on different types of information to allow the trained system to generate content – such as new works of art based on the styles seen, or new compound ideas based on the history of chemical research.

Foundation models are types of artificial intelligence systems that are trained on a broad set of unlabeled data that can be used for different tasks, with minimal fine-tuning. The unlabeled data includes in some instances imagery and/or language. In response to a short prompt being input into the foundation model, the system generates an output such as an entire essay, or a complex image, based on the parameters that are set forth in the input prompt. The foundation model is able to produce an output that attempts to meet the parameters even if the foundation model was never trained with specific training data that included the exact parameters, e.g., was never trained for that exact argument or to generate an image in that way.

Using self-supervised learning and transfer learning, foundation models can apply information that they have learnt about one situation to another. For example, like a human learns how to drive on one car, for example, and without too much effort, could learn how to drive other types of vehicles such as other cars, a truck, or a bus. The foundation model similarly is used to achieve proficiency in some new area without having to be trained completely from scratch. Foundation models seem to have inherent creativity in performing tasks such as stringing together coherent arguments or creating entirely original pieces of art. Foundation models are established in the technology of natural-language processing. One example of how foundation models are helpful is that for previous generation of AI techniques, if you wanted to build an AI model that could summarize bodies of text for you, you would need tens of thousands of labeled examples just for the summarization use case. With a pre-trained foundation model, the labeled data requirements are dramatically reduced. First, the foundation model is fine-tuned with a domain-specific unlabeled corpus to create a domain-specific foundation model. Then, using a much smaller amount of labeled data, potentially just a thousand labeled examples, a foundation model is trained for summarization. The domain-specific foundation model can be used for many tasks as opposed to the previous technologies that required building models from scratch in each use case. Foundation models are even applicable in areas such as computer programming coding analysis, generation, and repair.

Some foundation models are used for sentiment analysis. With pre-trained foundation models, sentiment analysis on a new language can be trained using as little as a few thousand sentences — 100 times fewer annotations required than previous models. Reducing labeling requirements will make it much easier for implementation in various technical areas. Systems that execute specific tasks in a single domain are giving way to broad AI that learns more generally and works across domains and problems. Foundation models, trained on large, unlabeled datasets and fine-tuned for an array of applications, are driving this shift.

LLMs are a category of foundation models trained on immense amounts of data making them capable of understanding and generating natural language and other types of content to perform a wide range of tasks. LLMs have been implemented at different levels to enhance their natural language understanding (NLU) and natural language processing (NLP) capabilities. This advancement of LLMs has occurred alongside advances in machine learning, machine learning models, algorithms, neural networks and the transformer models that provide the architecture for these AI systems.

LLMs are a class of foundation models, which are trained on enormous amounts of data to provide the foundational capabilities needed to drive multiple use cases and applications, as well as resolve a multitude of tasks. This LLM concept is in stark contrast to the idea of building and training domain specific models for each of these use cases individually, which is prohibitive under many criteria (most importantly cost and infrastructure), stifles synergies and can even lead to inferior performance.

LLMs represent a significant breakthrough in NLP and artificial intelligence. LLMs are accessible through interfaces like Open AI’s Chat GPT-3 and GPT-4, which have garnered the support of Microsoft. Other examples include Meta’s Llama models and Google’s bidirectional encoder representations from transformers (BERT/RoBERTa) and PaLM models. IBM has also recently launched its Granite model series on watsonx.ai, which has become the generative AI backbone for other IBM products like watsonx Assistant and watsonx Orchestrate.

In a nutshell, LLMs are designed to understand and generate text like a human, in addition to other forms of content, based on the vast amount of data used to train them. They have the ability to infer from context, generate coherent and contextually relevant responses, translate to languages other than English, summarize text, answer questions (general conversation and FAQs) and even assist in creative writing or code generation tasks. LLMs are able to do some or all of these tasks thanks to many, e.g., billions of, parameters that enable them to capture intricate patterns in language and perform a wide array of language-related tasks. LLMs are revolutionizing applications in various fields, from chatbots and virtual assistants to content generation, research assistance and language translation.

LLMs operate by leveraging deep learning techniques and vast amounts of textual data. These models are typically based on a transformer architecture, like the generative pre-trained transformer, which excels at handling sequential data like text input. LLMs consist of multiple layers of neural networks, each with parameters that can be fine-tuned during training, which are enhanced further by a numerous layer known as the attention mechanism, which dials in on specific parts of data sets.

During the training process, these models learn to predict the next word in a sentence based on the context provided by the preceding words. The model does this through attributing a probability score to the recurrence of words that have been tokenized— broken down into smaller sequences of characters. These tokens are then transformed into embeddings, which are numeric representations of this context.

To ensure accuracy, this process involves training the LLM on a large corpus of text (e.g., in the billions of pages), allowing the LLM to learn grammar, semantics and conceptual relationships through zero-shot and self-supervised learning. Once trained on this training data, LLMs can generate text by autonomously predicting the next word based on the input they receive, and drawing on the patterns and knowledge they have acquired. The result is coherent and contextually relevant language generation that can be harnessed for a wide range of NLU and content generation tasks.

Model performance can also be increased through prompt engineering, prompt-tuning, fine-tuning and other tactics like reinforcement learning with human feedback (RLHF) to remove the biases, hateful speech and factually incorrect answers known as “hallucinations” that are often unwanted byproducts of training on so much unstructured data. LLMs augment conversational AI in chatbots and virtual assistants to enhance the interactions that provide context-aware responses that mimic interactions with human agents.

LLMs also excel in content generation, automating content creation for blog articles, explanatory materials, and other writing tasks. LLMs aid in summarizing and extracting information from vast datasets, accelerating knowledge discovery. LLMs also play a vital role in language translation, breaking down language barriers by providing accurate and contextually relevant translations. LLMs can even be used to write code, or “translate” between programming languages. LLMs contribute to accessibility by assisting individuals with disabilities, including text-to-speech applications and generating content in accessible formats.

LLMs often include abilities such as:

Text generation: language generation abilities, such as writing emails, blog posts or other mid-to-long form content in response to prompts that can be refined and polished. An excellent example is retrieval-augmented generation (RAG).

Content summarization: summarize long articles, news stories, research reports, corporate documentation and even interaction history into thorough texts tailored in length to the output format.

AI assistants: chatbots that answer queries, perform backend tasks and provide detailed information in natural language as a part of an integrated, self-serve solution for handling inquiries.

Code generation: assists developers in building applications, finding errors in code and uncovering security issues in multiple programming languages, even “translating” between them.

Sentiment analysis: analyze text to determine a user’s tone in order to understand user feedback at scale and aid in brand reputation management.

Language translation: provides wider coverage to organizations across languages and geographies with fluent translations and multilingual capabilities.

Software service 504 (see FIG. 5A), executing on host platform 502 (see FIG. 5A) may provide one or more application programming interfaces (APIs) 520 that enable interaction with other software components via a set of data definitions and protocols. In some examples and features of the instant solution, the APIs provided may employ Simple Object Access Protocol (SOAP), Remote Procedure Calls (RPC), and Representational State Transfer (REST) techniques. In some examples and features of the instant solution, the plurality of APIs 520 send data to one or more decision subsystems 524 of the software service 504 to assist in decision-making. In some examples and features of the instant solution, the software service 504 stores data included in API requests or data generated during processing the API requests into one or more databases 506 (see FIG. 5A).

Software service 504 may provide one or more user interfaces (UIs) 522, such as a server-side hosted graphical user interface (GUI). In some examples and features of the instant solution, the UIs 522 provided employ template-based frameworks, component-based frameworks, etc. In some examples and features of the instant solution, these UIs 522 send data to one or more decision subsystems 524 of the software service 504 to assist with decision-making. In some examples and features of the instant solution, the software service 504 stores data included in UI requests or data generated during processing the UI requests into one or more databases 506.

Software service 504 may include one or more decision subsystems 524 that drive a decision-making process of the software service 504. In some examples and features of the instant solution, the decision subsystems 524 receive data from one or more APIs 520 as input into the decision-making process. In some examples and features of the instant solution, a decision subsystem 524 may receive data from one or more UIs 522 as input to the decision-making process. A decision subsystem 524 may gather service configuration or historical execution data from one or more databases 506 to aid in the decision-making process. A decision subsystem 524 may provide feedback to an API 520 or a UI 522.

An AI production system 530 may be used by a decision subsystem 524 in a software service 504 to assist in its decision-making process. The AI production system 530 includes one or more AI models 532 that are executed to generate a response, such as, but not limited to, a prediction, a categorization, a UI prompt, etc. In some examples and features of the instant solution, an AI production system 530 is hosted on a server. In some examples and features of the instant solution, the AI production system 530 is cloud-hosted. In some examples and features of the instant solution, the AI production system 530 is deployed in a distributed multi-node architecture.

An AI development system 540 creates one or more AI models 532. In some examples and features of the instant solution, the AI development system 540 utilizes data from one or more data sources 550 to develop and train one or more AI models 532. The data sources 550 may be local or third-party data sources. Further, the data provided by the data sources may be real-world or synthetic. In some examples and features of the instant solution, the AI development system 540 utilizes feedback data from one or more AI production systems 530 for new model development and/or existing model re-training. In some examples and features of the instant solution, the AI development system 540 resides and executes on a server. In some examples and features of the instant solution, the AI development system 540 is cloud hosted. In some examples and features of the instant solution, the AI development system 540 is deployed in a distributed multi-node architecture. In some examples and features of the instant solution, the AI development system 540 utilizes a distributed data pipeline/analytics engine.

Once an AI model 532 has been trained and validated in the AI development system 540, it may be stored in an AI model registry 560 for retrieval by either the AI development system 540 or by one or more AI production systems 530. The AI model registry 560 resides in a dedicated server in one example of the instant solution. In some examples and features of the instant solution, the AI model registry 560 is cloud-hosted. In some examples and features of the instant solution, the AI model registry 560 resides in the AI production system 530. In some examples and features of the instant solution, the AI model registry 560 is a distributed database.

FIG. 5B illustrates a process 500B for developing one or more AI models that support AI-assisted decision points. An AI development system 540 executes steps to develop an AI model 532 that begins with data extraction 541, in which data is loaded and ingested from one or more data sources 550. In some examples and features of the instant solution, historical model feedback data is extracted from one or more AI production systems 530.

Once the data has been extracted during data extraction 541, it undergoes data preparation 542 for model training. In some examples and features of the instant solution, this step involves statistical testing of the data to see how well it reflects real-world events, its distribution, the variety of data in the dataset, etc., and the results of this statistical testing may lead to one or more data transformations being employed to normalize one or more values in the dataset. In some examples and features of the instant solution, data deemed to be noisy is cleaned. A noisy dataset includes values that do not contribute to the training, such as, but not limited to, null and long string values. Data preparation 542 may be a manual process or an automated process using one or more of the elements and/or functions described and/or depicted herein.

Features of the data are identified and extracted during the feature extraction step 543. In some examples and features of the instant solution, a feature of the data is internal to the prepared data from the data preparation step 542. In some examples and features of the instant solution, a feature of the data requires a piece of prepared data from the data preparation step 542 to be enriched by data from another data source to be useful in developing the AI model 532. In some examples and features of the instant solution, identifying relevant features (relevant attributes) for model training are performed via an automated process using one or more of the elements and/or functions described and/or depicted herein. Once the features have been identified, the values of the features are collected into a dataset that will be used to develop the AI model 532.

The dataset output from the feature extraction step 543 is split 544 into a training and validation data set. The training data set is used to train the AI model 532, and the validation data set is used to evaluate the performance of the AI model 532 on unseen data.

The AI model 532 is trained and tuned 545 using the training data set from the data splitting step 544. In this step, the training data set is provided to an AI algorithm and an initial set of algorithm parameters which may be automatically determined based on the interdependence between the relevant attributes determined according to various embodiments. The performance of the AI model 532 is then tested within the AI development system 540 utilizing the validation data set from step 544. These steps may be repeated with adjustments to one or more algorithm parameters until the model's performance is acceptable based on various goals and/or results.

The AI model 532 is evaluated 546 in a staging environment (not shown) that resembles the target AI production system 530. This evaluation uses a validation dataset to ensure the performance in an AI production system 530 matches or exceeds expectations. In some examples and features of the instant solution, the validation dataset from step 544 is used. In some examples and features of the instant solution, one or more unseen validation datasets are used. In some examples and features of the instant solution, the staging environment is part of the AI development system 540, and the staging environment is managed separately from the AI development system 540. Once the AI model 532 has been validated, it is stored in an AI model registry 560, where it can be retrieved for deployment and future updates. In some examples and features of the instant solution, the model evaluation step 546 may be a manual process or an automated process using one or more of the elements and/or functions described and/or depicted herein.

In some examples and features of the instant solution, the AI development system includes a user interface (not shown). The user interface may be used to manage the development system infrastructure, the steps 541-548 within the development system, the interim data transmitted between the various steps 541-548, and the data sources 550.

Once an AI model 532 has been validated and published to an AI model registry 560, it may be deployed during the model deployment step 547 to one or more AI production systems 530. In some examples and features of the instant solution, the performance of deployed AI model 532 is monitored 548 by the AI development system 540. In some examples and features of the instant solution, AI model 532 feedback data is provided by the AI production system 530 to enable model performance monitoring 548, and the AI development system 540 periodically requests feedback data for model performance monitoring 548, which includes one or more triggers that result in the AI model 532 being updated by repeating steps 541-548 with updated data from one or more data sources 550.

FIG. 5C illustrates a process 500C for utilizing an AI model that supports AI-assisted decision points. As stated previously, the AI model utilization process depicted herein reflects ML, which is a particular branch of AI, but this instant solution is not limited to ML and is not limited to any AI algorithm or combination of algorithms.

Referring to FIG. 5C, an AI production system 530 may be used by a decision subsystem 524 in software service 504 to assist in its decision-making process. The AI production system 530 provides an API 534, executed by an AI server process 536 through which requests can be made. In some examples and features of the instant solution, a request may include an AI model 532 identifier to be executed based on the type of request. In some examples and features of the instant solution, a data payload (e.g., to be input to the AI model during execution) is included in the request. The data payload may include API 520 data from software service 504, UI 522 data from software service 504 or data from other software service 504 subsystems (not shown).

Upon receiving the API 534 request, the AI server process 536 may transform 537 the data payload or portions of the data payload to be valid feature values in an AI model 532. Data transformation 537 may include, but is not limited to, combining data values, normalizing data values, and enriching the incoming data with data from other data sources 550. Once the data transformation occurs, the AI server process 536 executes the appropriate AI model 532 using the transformed input data. Upon receiving the execution result, the AI server process 536 responds to the API requester, which is a decision subsystem 524 of software service 504. In some examples and features of the instant solution, the response may result in an update to a UI 522 in software service 504. In some examples and features of the instant solution, the response includes a request identifier that can be used later by the software service 504 to provide feedback on the performance of the AI model 532. In some examples and features of the instant solution, a model feedback record may be added into a model feedback data 538 by the AI server process 536.

In some examples and features of the instant solution, the API 534 includes an interface to provide AI model 532 feedback after an AI model 532 execution response has been processed. This mechanism enables the requester to provide feedback on the accuracy of the AI model 532 results. In some examples and features of the instant solution, the feedback interface includes the identifier of the initial request so that it can be used to associate the feedback with the request. Upon receiving a call into the feedback interface of the API 534, the AI server process 536 creates and adds a model feedback record into the model feedback data 538 which holds historical model feedback records. In some examples and features of the instant solution, the records in this model feedback data 538 are provided to model performance monitoring 548 in the AI development system 540. This model feedback data is streamed to the AI development system 540 or may be provided upon request. In some examples and features of the instant solution, the model feedback records in the model feedback data 538 are used as an input for retraining the AI model 532.

In some examples and features of the instant solution, the AI production system 530 includes a user interface (not shown). The user interface may be used to manage the production system infrastructure, the components of the production system 530-538, and the operation of the AI production system and its components.

The above embodiments may be implemented in hardware, in a computer program executed by a processor, in firmware, or in a combination of the above. A computer program may be embodied on a computer-readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

An exemplary storage medium may be coupled to the processor such that the processor may read information from, and write information to, the storage medium. In the alternative, the storage medium may be integral to the processor. The processor and the storage medium may reside in an application-specific integrated circuit (“ASIC”). In the alternative, the processor and the storage medium may reside as discrete components.

What is claimed is:

1. A method comprising:
receiving video content of an operation being performed;
generating, via a first machine learning (ML) model and based on the video content, a description of at least one action being performed that is part of the operation;
extracting, via a second ML model, spoken utterances from the video content;
generating a digital document comprising
a textual description of steps that are performed to perform the operation and
image placeholders,
based on execution of a third ML model on the description of the at least one action and the spoken utterances that are extracted, wherein the digital document is an output of the third ML model; and
adding digital images to the digital document based on the image placeholders.

2. The method of claim 1, wherein the adding comprises:
converting a textual description of a step from the digital document into a vector,
identifying an image vector that corresponds to the vector based on execution of a multi-modal ML model on the vector and multiple image vectors, and
adding a digital image corresponding to the identified image vector to an image placeholder corresponding to the step within the digital document.

3. The method of claim 1, wherein the extracting spoken utterances comprises extracting audio from the video content, converting the audio to text, and identifying the spoken utterances from the text.

4. The method of claim 1, wherein the generating the description of the at least one action comprises sampling video frames from the video content, executing the first machine learning model on the video frames to identify skeletal positions of an agent within the video content, and executing the first machine learning model or another machine learning model on the video frames to identify an object within the video content, and
wherein the description of the at least one action is based on the identified skeletal positions and on the identified object.

5. The method of claim 4, further comprising executing the first ML model, the other ML model, or an additional ML model on the identified skeletal positions and the identified object to determine the action being performed by the agent with respect to the object, wherein the description of the at least one action includes the action being performed by the agent with respect to the object.

6. The method of claim 1, further comprising generating a prompt that includes the description of the at least one action, the extracted spoken utterances, and a task to be performed by the third ML model, wherein the generating the digital document comprises executing the third ML model on the prompt.

7. The method of claim 1, further comprising executing the third ML model on the video content to generate a descriptive summary of the video content, wherein the generating the digital document further comprises executing the third ML model on the generated descriptive summary of the video content.

8. The method of claim 1, wherein the first, second, and third machine learning models are the same machine learning model.

9. A computer system comprising:
a processor set;
one or more computer-readable storage media; and
program instructions stored on the one or more computer-readable storage media to cause the processor set to perform operations comprising:
receiving video content of an operation being performed;
generating, via a first machine learning (ML) model and based on the video content, a description of at least one action being performed that is part of the operation;
extracting, via a second ML model, spoken utterances from the video content;
generating a digital document comprising a textual description of steps that are performed to perform the operation and image placeholders, based on execution of a third ML model on the description of the at least one action and the spoken utterances that are extracted, wherein the digital document is an output of the third ML model; and
adding digital images to the digital document based on the image placeholders.

10. The computer system of claim 9, wherein the adding comprises:
converting a textual description of a step from the digital document into a vector,
identifying an image vector that corresponds to the vector based on execution of a multi-modal ML model on the vector and multiple image vectors, and
adding a digital image corresponding to the identified image vector to an image placeholder corresponding to the step within the digital document.

11. The computer system of claim 9, wherein the extracting spoken utterances comprises extracting audio from the video content, converting the audio to text, and identifying the spoken utterances from the text.

12. The computer system of claim 9, wherein the generating the description of the at least one action comprises sampling video frames from the video content, executing the first machine learning model on the video frames to identify skeletal positions of an agent within the video content, and executing the first machine learning model or another machine learning model on the video frames to identify an object within the video content, and
wherein the description of the at least one action is based on the identified skeletal positions and on the identified object.

13. The computer system of claim 12, wherein the operations further comprise executing the first ML model, the other ML model, or an additional ML model on the identified skeletal positions and the identified object to determine the action being performed by the agent with respect to the object, wherein the description of the at least one action includes the action being performed by the agent with respect to the object.

14. The computer system of claim 9, wherein the operations further comprise generating a prompt that includes the description of the at least one action, the extracted spoken utterances, and a task to be performed by the third ML model, wherein the generating the digital document comprises executing the third ML model on the prompt.

15. The computer system of claim 9, wherein the operations further comprise executing the third ML model on the video content to generate a descriptive summary of the video content, wherein the generating the digital document further comprises executing the third ML model on the generated descriptive summary of the video content.

16. The computer system of claim 9, wherein the first, second, and third machine learning models are the same machine learning model.

17. A computer program product comprising:
one or more computer-readable storage media; and
program instructions stored on the one or more computer-readable storage media to perform operations comprising:
receiving video content of an operation being performed;
generating, via a first machine learning (ML) model and based on the video content, a description of at least one action being performed that is part of the operation;
extracting, via a second ML model, spoken utterances from the video content;
generating a digital document comprising a textual description of steps that are performed to perform the operation and image placeholders, based on execution of a third ML model on the description of the at least one action and the spoken utterances that are extracted, wherein the digital document is an output of the third ML model; and
adding digital images to the digital document based on the image placeholders.

18. The computer program product of claim 17, wherein the adding comprises:
converting a textual description of a step from the digital document into a vector,
identifying an image vector that corresponds to the vector based on execution of a multi-modal ML model on the vector and multiple image vectors, and
adding a digital image corresponding to the identified image vector to an image placeholder corresponding to the step within the digital document.

19. The computer program product of claim 17, wherein the extracting spoken utterances comprises extracting audio from the video content, converting the audio to text, and identifying the spoken utterances from the text.

20. The computer program product of claim 17, wherein the operations further comprise generating a prompt that includes the description of the at least one action, the extracted spoken utterances, and a task to be performed by the third ML model, wherein the generating the digital document comprises executing the third ML model on the prompt.
